(19) United States
(12) Patent Application Publication
(10) Pub. No.: US 2024/0110801 A1
(43) Pub. Date: Apr. 4, 2024

(54) APPARATUS AND METHOD FOR GUIDING CUSTOMIZED ROUTE BASED ON DISABILITY INFORMATION

(71) Applicant: DOT INCORPORATION, Seoul (KR)

(72) Inventors: Ji Ho KIM, Incheon (KR); Ju Yoon KIM, Gwangmyeong-si (KR); Hyeon Cheol PARK, Gwangmyeong-si (KR)

(21) Appl. No.: 17/994,309

(22) Filed: Nov. 26, 2022

(30) Foreign Application Priority Data
Sep. 29, 2022 (KR) 10-2022-0124072

(51) Int. Cl. G01C 21/34; G01C 21/36

(52) U.S. Cl. CPC G01C 21/3461; G01C 21/3484; G01C 21/3617; G01C 21/362

(57) ABSTRACT

Provided are an apparatus and method for guiding customized route based on disability information, and the method of guiding customized route based on disability information includes selecting candidate routes from a departure position to a destination position from or to which a user intends to move, obtaining disability information including a disability type and a disability degree of the user, evaluating movement convenience of the user for each of the candidate routes in consideration of the disability information, and determining guidance route information from the candidate routes in consideration of an evaluation result.

### CROSS REFERENCE TO RELATED APPLICATION

This application claims priority from and the benefit of Korean Patent Application No. 10-2022-0124072, filed on Sep. 29, 2022, which is hereby incorporated by reference for all purposes as if fully set forth herein.

### BACKGROUND

### Field

The disclosure relates to an apparatus and method for guiding customized route based on disability information.

### Discussion of the Background

Due to the recent 4^{th} industrial revolution and the development of IT technology, unmanned devices (e.g., kiosks or the like), which replace conventional workers in providing various information and services, have appeared in large numbers, and the frequency of their use is increasing worldwide. However, since most of the current unmanned devices mainly are produced, disseminated, and operated towards a target of non-disabled users and users of younger age groups, it is hardly difficult for the information vulnerable users, such as disabled users and elderly users, to access and use the services provided by the current unmanned devices.

In this regard, the number of disabled people accounts for about 15% of the world's population, reaching 1 billion people worldwide. In addition, the aging population has been intensified from countries of G20, and thus, it is expected that the aged population ratio reaches about 17% of the world's population by the year of 2050. After all, in the future, the disabled people or the elderly may increase to about 3 out of 10 of the total population. In addition, considering that the adoption of unmanned devices is an inevitable trend that no one can resist due to the lack of service workers, it is expected that information inequality in information vulnerable users, such as the disabled users and the elderly users, continues to intensify and becomes a big social issue.

Meanwhile, in the conventional navigation service, map and destination information is mainly transmitted from a server to a terminal, and a route is calculated and guided. In this case, the calculation of a current position of a user is affected by the signal transmission state and signal transmission time from a communication base station, and is usually performed using signals from global positioning system (GPS) satellites. Further, such a general navigation service cannot provide route guidance that is precise enough and consistent with the real-time situation to allow a disabled user to move while avoiding elements that can affect the movement of the disabled user, such as obstacles on the path or other pedestrians and vehicles that change in real time.

In addition, since route information cannot be clearly transmitted to the disabled user by simply displaying a route from a current position to a destination on the map, it is required to develop a navigation service customized for the disabled user, which has a function that may specifically guide how to change the direction of travel from the current position of the user in order to follow the route to the destination in every situation according to a user's moving state and in which guidance information may be output in a manner recognizable by the user in consideration of a disability type of the user.

The background art of the disclosure is disclosed in Korean Patent Registration No. 10-2079061.

### SUMMARY

The disclosure is directed to providing an apparatus and method for guiding customized route based on disability information, capable of searching for and outputting an optimal route from a departure position to a destination position, from or to which a user intends to move, by considering movement convenience according to a disability type and a disability degree of the user.

However, the technical problems to be achieved by embodiments of the disclosure are not limited to the technical problems as described above, and other technical problems may exist.

According to an aspect of an embodiment, there is provided a method of guiding customized route based on disability information, the method including selecting candidate routes from a departure position to a destination position from or to which a user intends to move, obtaining disability information comprising at least one of a disability type or a disability degree of the user, evaluating movement convenience of the user for each of the candidate routes in consideration of the disability information, and determining guidance route information from the candidate routes in consideration of an evaluation result.

In an embodiment, in the evaluating of the movement convenience, the movement convenience for each of the selected candidate routes may be evaluated in consideration of at least one of position information on an interference object located in a target space, which comprises at least one of the departure position or the destination position, and obstructing the movement of the user, and position information on an auxiliary object located in the target space and assisting the movement of the user.

In an embodiment, in the evaluating of the movement convenience, when the candidate route is a route on which the interference object is present or the auxiliary object is not present, the candidate route may be evaluated to be lower in movement convenience than the other candidate routes.

In an embodiment, the interference object may comprise at least one of a first type object disposed being fixed in the target space or a second type object variably disposed in the target space.

In an embodiment, the auxiliary object may comprise at least one of a braille guidance block, an elevator, a wheelchair lift, or a guidance traffic light.

In an embodiment, the method of guiding customized route based on disability information may further comprise providing the determined guidance route information to a user terminal of the user.

In an embodiment, in the providing of the guidance route information, the guidance route information may be output by an information output method determined to correspond to the disability information.

In an embodiment, in the obtaining of the disability information, the disability information may be estimated by receiving the disability information from a user terminal of the user, determining the disability information on the basis of a user input applied to a target device for providing the guidance route information, or analyzing image data obtained by capturing an image of the user.

In an embodiment, the providing of the guidance route information may include obtaining position information of the user, and outputting guiding/guidance information on a proceeding direction and progress of the user on the basis of the guidance route information and the position information.

In an embodiment, in the obtaining of the position information, the position information may be calculated by using information from a positioning sensor mounted on the user terminal or an infrastructure provided in a target space comprising at least one of the departure position or the destination position.

According to an aspect of another embodiment, there is provided an apparatus for guiding customized route based on disability information, the apparatus including a candidate setting unit configured to select candidate routes from a departure position to a destination position from or to which a user intends to move, a user identification unit configured to obtain disability information comprising at least one of a disability type or a disability degree of the user, a route evaluation unit configured to evaluate movement convenience of the user for each of the candidate routes in consideration of the disability information, and a route selection unit configured to determine guidance route information from the candidate routes in consideration of an evaluation result.

In an embodiment, the route evaluation unit may evaluate the movement convenience for each of the selected candidate routes is evaluated in consideration of at least one of position information on an interference object located in a target space, which may comprise at least one of the departure position or the destination position, or obstructing the movement of the user, and position information on an auxiliary object located in the target space and assisting the movement of the user.

In an embodiment, the route evaluation unit may evaluate the candidate route to be lower in movement convenience than the other candidate routes when the candidate route is a route on which the interference object is present or the auxiliary object is not present.

In an embodiment, the customized route guidance apparatus may comprise an output unit configured to provide the determined guidance route information to a user terminal of the user.

in addition, the output unit may output the guidance route information by an information output method determined to correspond to the disability information.

In an embodiment, the user identification unit may estimate the disability information by receiving the disability information from a user terminal of the user, determining the disability information on the basis of a user input applied to a target device for providing the guidance route information, or analyzing image data obtained by capturing an image of the user.

In an embodiment, the output unit may calculate the position information by using information from a positioning sensor mounted on the user terminal, or using an infrastructure provided in a target space including the departure position and the destination position, and outputs guiding/guidance information on a proceeding direction and progress of the user on the basis of the guidance route information and the position information.

According to an aspect of another embodiment, there is provided a customized route guidance system based on disability information, the system including a target device configured to receive information on a departure position and a destination position according to the movement of a user, receive guidance route information for reaching the destination position from the departure position from a route guidance apparatus, and output the guidance route information, and the route guidance apparatus configured to select candidate routes from the departure position to the destination position, obtain disability information comprising at least one of a disability type or a disability degree of the user, evaluate movement convenience of the user for each of the candidate routes in consideration of the disability information, determine guidance route information from the candidate routes in consideration of an evaluation result, and provide the guidance route information to a user terminal.

In an embodiment, in the evaluating of the movement convenience, the movement convenience for each of the selected candidate routes is evaluated in consideration of at least one of position information on an interference object located in a target space, which comprises at least one of the departure position or the destination position, and obstructing the movement of the user, or position information on an auxiliary object located in the target space and assisting the movement of the user.

In an embodiment, the route guidance apparatus further configured to provide the determined guidance route information to a user terminal of the user, and in the providing of the guidance route information, the guidance route information is output by an information output method determined to correspond to the disability information.

In an embodiment, in the obtaining of the disability information, the disability information is estimated by receiving the disability information from a user terminal of the user, determining the disability information on the basis of a user input applied to a target device for providing the guidance route information, or analyzing image data obtained by capturing an image of the user.

The above-described means for solving problems are merely illustrative, and should not be construed as limiting the disclosure. In addition to the exemplary embodiments described above, additional embodiments may exist in the drawings and detailed description of disclosure.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic configuration view of a customized route guidance system based on disability information according to an embodiment of the disclosure;

FIG. 2 is a conceptual view for describing a process of estimating the disability information using image data obtained by capturing an image of a user;

FIG. 3 is a conceptual view for describing interference objects and auxiliary objects located in a target space;

FIG. 4 is a schematic configuration view of an apparatus for guiding customized route based on disability information according to an embodiment of the disclosure; and

FIG. 5 is an operation flowchart illustrating a method of guiding customized route based on disability information according to an embodiment of the disclosure.

### DETAILED DESCRIPTION

Hereinafter, embodiments of the disclosure will be described in detail with references to the accompanying drawings in such a manner that those of ordinary skill in the art to which the disclosure pertains can easily implement them. However, the disclosure may be implemented in several different forms and is not limited to the embodiments described herein. In an embodiment, in order to clearly explain the disclosure in the drawings, portions irrelevant to the descriptions are omitted, and similar reference numerals are attached to similar portions throughout the specification.

Throughout this specification, when a part is “connected” with another part, it is not only “directly connected” but also “electrically connected”, or “indirectly connected” with another element interposed therebetween.

Throughout this specification, when it is said that a member is located “on”, “on an upper portion of”, “on a top of”, “under”, “on a lower portion of”, and “on a bottom of” another member, this means that a member is located on the other member. It includes not only the case where they are in contact, but also the case where another member exists between two members.

Throughout this specification, when a portion or a part “includes” a component or an element, it means that other components or elements may be further included, rather than excluding other components, unless otherwise stated.

The disclosure relates to an apparatus and method for guiding customized route based on disability information.

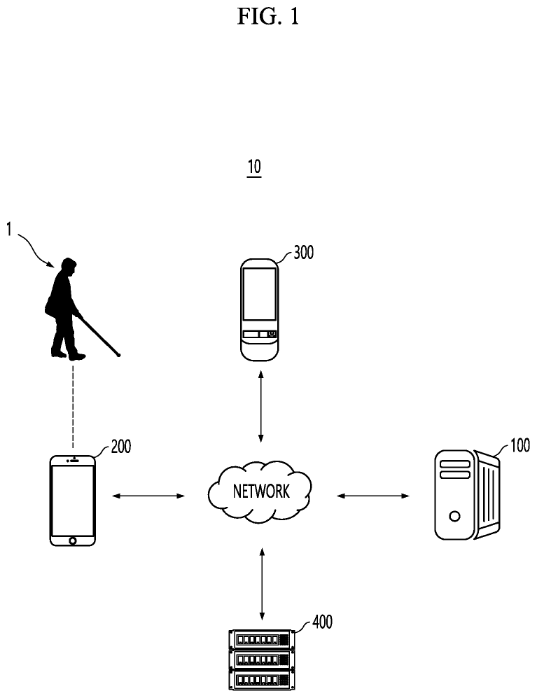

FIG. 1 is a schematic configuration view of a customized route guidance system based on disability information according to an embodiment of the disclosure.

Referring to FIG. 1, a customized route guidance system 10 based on disability information according to an embodiment of the disclosure may include a customized route guidance apparatus 100 based on disability information (hereinafter, referred to as a “route guidance apparatus 100”) according to an embodiment of the disclosure, an information terminal 300, a user terminal 200, and an external server 400.

The route guidance apparatus 100, the information terminal 300, the user terminal 200, and the external server 400 may communicate with one another via a network 20. The network 20 refers to a connection structure which enables information to be exchanged between each node, such as terminals and servers. Examples of the network 20 may include a 3^{rd} Generation Partnership Project (3 GPP) network, Long Term Evolution (LTE) network, 5G network, World Interoperability for Microwave Access (WIMAX) network, Internet, Local Area Network (LAN), Wireless Local Area Network (Wireless LAN), Wide Area Network (WAN), Personal Area Network (PAN), a WIFI network, a Bluetooth network, a satellite broadcasting network, an analog broadcasting network, a Digital Multimedia Broadcasting (DMB) network, or the like. However, the network 20 is not limited to those examples described above.

In an embodiment, although not shown in the figures, the customized route guidance system 10 may include an auxiliary terminal (not shown) carried by a disabled user or the like. The auxiliary terminal (not shown) may be, e.g., a device capable of outputting braille-based information for a visually impaired user (e.g., a blind person or the like). In an example embodiment, the device capable of outputting braille-based information may include a braille watch, a braille pad, or the like. which has a display including a plurality of braille protrusion members. However, the auxiliary terminal is not limited to the device for the visually impaired user. Thus, the auxiliary terminal (not shown) herein may further include a wide range of various devices that can be used to assist various information vulnerable users such as disabled users and elderly users. For example, the auxiliary terminal (not shown) may be a concept including various devices for assisting the user's vision, mobility, hearing, cognitive ability, and the like, such as a hearing aid, an interpreter, a cane, an electric wheelchair, and the like. In an embodiment, according to the implementation of the disclosure, a user interacting with the information terminal 300 may have (possess) only the user terminal 200 without a separate auxiliary terminal (not shown) or have (possess) both the auxiliary terminal (not shown) and the user terminal 200.

The user terminal 200 may include any type of wireless communication device, e.g., a smartphone, a smart pad, a tablet PC, and the like, and terminals for PCS (Personal Communication System), GSM (Global System for Mobile communication), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), and Wibro (Wireless Broadband Internet).

For reference, in relation to the embodiment of the disclosure, a ‘target space’ mainly means a multi-use facility or space used by many people, such as subway stations, public transportation platforms, train stations, airports, shopping malls, department stores, parks, movie theaters, schools, stadiums, gyms, public institutions, and the like. However, the target space is not limited to those described above.

In an embodiment, the information terminal 300 may be installed in the target space for the purpose of providing the user with route information for destinations, such as major facilities (toilets, elevators, escalators, or the like), stores (shops), and specific positions, or the like in the target space. However, the information terminal 300 is not limited to those described above, and may also be installed for the purpose of providing the user (passerby) with information on the target space or various types of information that is not limited to the target space.

In an embodiment, in the description of the embodiment of the disclosure, the information terminal 300 may be a concept that broadly includes an unmanned device, a kiosk, a digital signage, and the like. In an embodiment, as will be described in detail below, the information terminal 300 disclosed herein may be designed to provide a user interface (UI)/user experience (UX) in a customized manner according to user information, in consideration of information accessibility of the users corresponding to the information vulnerable users, such as the disabled user, the elderly user, and the like.

In an embodiment, in the description of the embodiment of the disclosure, the route guidance apparatus 100 may be configured to be mounted in the information terminal 300 or the user terminal 200, and may be a sub-component (e.g., an application, a program, or the like) of the information terminal 300 or the user terminal 200 that performs an operation of determining contents of route guidance information provided to a user 1 through the information terminal 300 or the user terminal 200 and controlling (changing) elements associated with the UI/UX of the information terminal 300 or the user terminal 200 to match the user's disability information. In another example, according to the embodiment of the disclosure, the route guidance apparatus 100 may be a device or a server provided separately from the information terminal 300 or the user terminal 200 and configured to perform operations of determining contents of route guidance information provided to the user 1, providing the contents to the information terminal 300 or the user terminal 200, and controlling (changing) elements associated with the UI/UX of the information terminal 300 or the user terminal 200.

In the description of the embodiment of the disclosure, the external server 400 may be configured to store user information for each user, map data on a target space, object-related data recognized for the target space, and the like in advance and provide necessary user information, map information, object information, and the like to the route guidance apparatus 100. In other words, the external server 400 may have a function of providing spatial information (e.g., positions of major facilities, map information, or the like) on the target space, in which the information terminal 300 with which the user interacts is located, to the route guidance apparatus 100. In an example embodiment, the external server 400 may retain the user information in advance in a manner of receiving user information of a user who has (possesses) the corresponding user terminal 200 from the user terminal 200 in advance and storing the user information as the user information for the corresponding user.

In an embodiment, according to an embodiment of the disclosure, the user information that is secured in advance by the external server 400 and provided to the route guidance apparatus 100 may include personal information such as a user's name, age, gender, address, and contact information, as well as disability information such as a disability type and a disability grade (level) in the case of a disabled user.

The route guidance apparatus 100 may obtain at least one piece of information on a departure position and a destination position from and to which the user 1 intends to move.

In an example embodiment, the route guidance apparatus 100 may obtain at least one piece of information on the departure position and information on the destination position, on the basis of a position selection input of the user 1 applied to the user terminal 200 or the information terminal 300. In this regard, when the position selection input applied to the user terminal 200 or the information terminal 300 includes only the user input for the destination position, information on a current position of the user 1 may be replaced with the information on the departure position.

In an embodiment, according to an embodiment of the disclosure, the route guidance apparatus 100 may operate to obtain, from the user terminal 200, prior search data related to predetermined route information that can be provided through the target device, and provide route guidance information that is generated on the basis of the information on a destination position, wherein the destination position is determined on the basis of a search input matching the obtained prior search data.

In this regard, in the case of a visually impaired user or the like, since the visually impaired user has much difficulties in walking outdoors compared to a non-disabled user, and thus, has a tendency to search in advance information on a destination (route guide, information by floor inside a building, indoor facility information, and the like) by using the user terminal 200 such as a smart phone before leaving for the journey, the route guidance apparatus 100 may search for meaningful prior search data from the user terminal 200, and may provide targeted guide data conformable to the searched prior search data, so that the information terminal 300 may immediately provide the targeted customized route guidance information to the user by using the previously searched result from the user terminal 200 or the like.

In an example embodiment, the prior search data may broadly include web page access history (URL information or the like) obtainable by the user terminal 200, text data such as online search terms, image data, voice data, messenger, SNS data, user log, or the like.

In an embodiment, the providing of the route guidance information based on the search input matching the prior search data may include the example followings: when there is a search history that a particular store (shop) located in the target space to which the information terminal 300 is searched by the user terminal 200, the business information of the corresponding store (shop), the route information for reaching the corresponding store (shop), and the like are automatically provided by the information terminal 300 although if the user does not apply an additional search input to the information terminal 300.

In this regard, the route guidance apparatus 100 may include a user log (search information) analyzer for matching information corresponding to the prior search data among providable information obtained by the information terminal 300. For example, the user log analyzer may include a keyword extraction function based on the text mining. In another example, the user log analyzer may include an artificial intelligence model (e.g., an artificial intelligence model based on a convolutional neural network (CNN) including an image analysis or an image sorting function.

In an embodiment, the route guidance apparatus 100 may select candidate routes between the obtained departure position and destination position of the user 1. For example, the route guidance apparatus 100 may primarily set a plurality of candidate routes that may be considered in order for the user 1 to start the movement at the departure position and reach the destination position, and may provide optimized route guidance information to the user 1 by evaluating movement convenience for each of the plurality of candidate routes as will described in detail below. In an embodiment, according to an embodiment of the disclosure, the route guidance apparatus 100 may operate to determine the plurality of candidate routes according to particular movement types, such as a walking movement type, a combination movement type of riding on public transport and walking, and the like, on the basis of a movement type selection input from the user 1, a separation distance from the departure position to the destination position, and the like.

In an embodiment, the route guidance apparatus 100 may obtain disability information including a disability type and a disability degree of the user. In this regard, in the description of the embodiment of the disclosure, the disability type of the user may include at least one of a visual impairment type, a hearing-impaired type, and a physical disability type. In an embodiment, in the description of the embodiment of the disclosure, the disability degree of the user may include information indicating a degree of deterioration in physical ability corresponding to the disability type of the user, and may refer to, for example, disability degree information according to Criteria for Judgment by Disability Type, but the disability degree of the user is not limited to the disability degree information. In an embodiment, according to an embodiment of the disclosure, when a particular user is a user having a combination of different types of disabilities, the disability information on the corresponding user may be obtained in the form of complex information including a plurality of disability types and a disability degree according to each of the disability types.

In this regard, according to an embodiment of the disclosure, the route guidance apparatus 100 may receive the disability information from the user terminal 200 of the user. In another example, the route guidance apparatus 100 may determine the disability information of the user currently interacting with the target device on the basis of a user input applied to the target device such as the information terminal 300.

In still another example, the route guidance apparatus 100 may estimate the disability information by analyzing image data obtained by capturing an image of the corresponding user. In an example embodiment, the route guidance apparatus 100 may obtain image data captured by an infrastructure (not shown) such as a closed circuit television (CCTV) provided in a space in which the user interacts (more particularly, an act of manipulating the target device by the user, an act of providing information that the user wants to obtain through the target device, or the like) with the target device, or may obtain image data, which is captured by a camera module (not shown) provided in the information terminal 300 in a process in which a particular user accesses the information terminal 300 or manipulates the information terminal 300 using a peripheral part of the information terminal 300, from the information terminal 300.

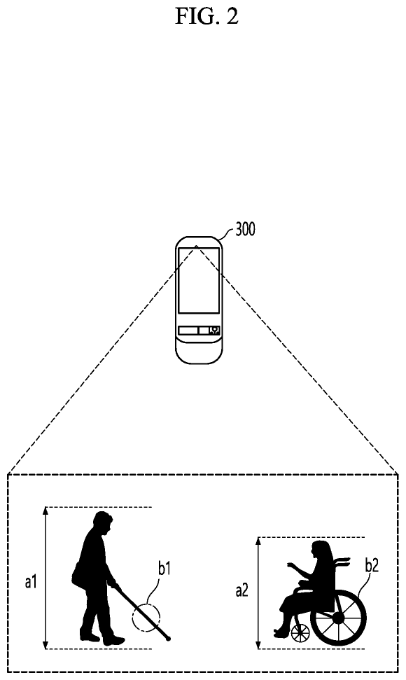

FIG. 2 is a conceptual view for describing a process of estimating the disability information using image data obtained by capturing an image of a user.

Referring to FIG. 2, the route guidance apparatus 100 may operate to estimate the disability information from at least one of appearance characteristics, behavior characteristics, and object characteristics of the user reflected in the image data.

According to an embodiment of the disclosure, the appearance characteristics of the user may include the height, appearance, physique, and the like of the user. In an embodiment, the behavior characteristics of the user may include the gait, a body movement, and the like of the user. In an embodiment, the object characteristics of the user may include identification of a tool, the user terminal 200, an auxiliary terminal (not shown), clothes, a walking assistance aids, a wheelchair, and the like which the user possess.

In an example embodiment, referring to FIG. 2, the route guidance apparatus 100 may obtain height information a1 of a first user (the user shown on a left side of FIG. 2) reflected in the image data, object information b1 indicating that the user is holding a cane, height information a2 of a second user (the user shown on a right side of FIG. 2) reflected in the image data, and object information b2 indicating that the user is riding in a wheelchair, and may use the pieces of height information a1 and a2 and the pieces of object information b1 and b2 to estimate the existence of disability, a disability type, a disability degree, and the like of each user.

In another example, in the case of a visually impaired user who wears “sunglasses” and walks while carrying a “white cane”, the route guidance apparatus 100 may identify the sunglasses, the white cane, and the like as the object characteristics of the corresponding user from the image in which the corresponding user appears, and may recognize that the corresponding user is a visually impaired user in response to the identification. Similarly, the route guidance apparatus 100 may recognize that the user is a visually impaired user by identifying characteristics in which the user walks while striking guidance blocks on the ground with the white cane as the behavior characteristics. In this regard, the route guidance apparatus 100 may have a pre-trained artificial intelligence model (e.g., a deep learning algorithm that detects an appearance object through semantic segmentation or the like) for detecting the appearance characteristics, the behavior characteristics, the object characteristics, and the like from the received image.

In summary, the disability information necessary to change the elements associated with the UI/UX provided through the information terminal 300 into customized settings suitable for the user, and individually evaluate the movement convenience for each of the candidate routes from the departure position to the destination position, from or to which the user 1 intends to move, may broadly include information obtained in advance through the user terminal 200, the external server 400, or the like for the corresponding user, or information analyzed in real time by analyzing the image data obtained by capturing an image of the user using the information terminal 300.

In an embodiment, the route guidance apparatus 100 may evaluate the movement convenience for each of the plurality of candidate routes from the departure position to the destination position in consideration of the obtained disability information of the user 1. For example, the route guidance apparatus 100 may operate to calculate a score associated with the movement convenience for each of the plurality of candidate routes, and may operate such that as the calculated score has a higher value, the corresponding route has a high probability of being selected as guidance route information to be finally recommended to the user 1.

Meanwhile, according to an embodiment of the disclosure, for each of the plurality of candidate routes, the route guidance apparatus 100 may calculate a score indicating the walking movement convenience of the user 1 for a movement section, which is included in the candidate route and in which the walking movement type is applied.

Particularly, the route guidance apparatus 100 may evaluate the movement convenience for each of the candidate routes by considering at least one from among position information on interference objects, which are located in a target space including the departure position and the destination position and obstruct the movement of the user, and position information on auxiliary objects located in the target space and assist the movement of the user 1.

In an embodiment, the route guidance apparatus 100 may determine the guidance route information to be finally provided to the user 1 from among the candidate routes in consideration of an evaluation result of the movement convenience for each of the candidate routes.

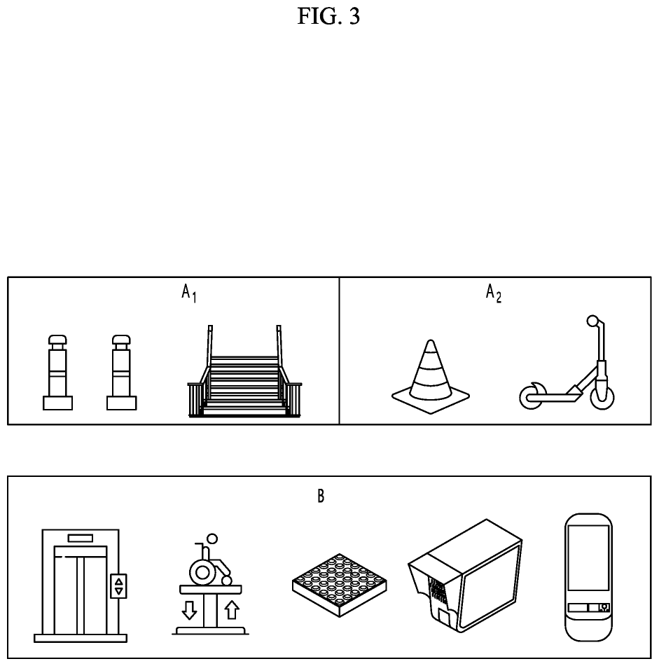

FIG. 3 is a conceptual view for describing the interference objects and the auxiliary objects located in the target space.

Referring to FIG. 3A, the interference objects interfering with the movement of the user 1 may include a first type object A₁ including a bollard, stairs, a structure larger than or equal to a predetermined specification, or the like disposed at a fixed position in the target space, and a second type object A₂ including a personal mobility device, a temporary road structure, another pedestrian, or the like which is variably disposed in the target space.

In this regard, according to an embodiment of the disclosure, the route guidance apparatus 100 may obtain spatial data (e.g., topographical maps, cadastral maps, indoor drawing data, digital twin modeling data, previously captured images, and the like) of the target space from the external server 400, and obtain information (the existence, detailed position, standard, or the like of each object) on the first type object A₁ among the interference objects on the basis of the obtained spatial data.

In an embodiment, according to an embodiment of the disclosure, the route guidance apparatus 100 may obtain information (the existence, detailed position, standard, or the like of each object) on the second type object A₂ on the basis of report information, which is provided from the external server 400 or a user terminal (not shown) of another user, related to the real-time placement of the object in the target space.

For example, since information on the objects that may be variably disposed in the target space may be omitted from the spatial data of the target space, which is secured in advance, due to specific events (e.g., traffic accidents, pedestrian congestion, temporary construction progress, and the like) that may occur in the target space, the route guidance apparatus 100 may determine the real-time state of the target space on the basis of report information crowd-sourced from user terminals (not shown) of other users who have passed through the target space in advance, and by reflecting this, the route guidance apparatus 100 can provide the route guidance information while continuously identifying information on the variable interference objects that may interfere with the movement (walking) of the disabled user.

In an embodiment, referring to FIG. 3B, an auxiliary object B for assisting the movement of the user 1 may include, but is not limited to, a braille guidance block, an elevator, a wheelchair lift, a guidance traffic light, and a kiosk that provides a UPUX for a disabled user.

When the candidate route is a route in which the above-described interference object is included on the route or the auxiliary object is not included on the route, the candidate route may be evaluated to be lower in movement convenience than the other candidate routes.

Meanwhile, according to an embodiment of the disclosure, object type classification and an importance (weight), which are considered to evaluate the movement convenience for each candidate route, may be determined for each object on the basis of the disability information of the user 1. For example, in the movement convenience evaluation for searching for route guidance information to be provided to a blind user, the braille guidance block may be treated as the auxiliary object B, and thus the more the braille guidance block is included in the route, the higher the score for movement convenience may be calculated. On the other hand, in the movement convenience evaluation for searching for route guidance information to be provided to a physically disabled user who will move while riding in a wheelchair, the braille guidance block, which is an object of the same type, may be treated as the interference object A in consideration of the fact that it may be difficult for the physically disabled user to pass through the upper surface of the area, in which the braille guidance block is placed, while riding in the wheelchair as compared to the general sidewalk area.

In an embodiment, according to an embodiment of the disclosure, the physically disabled user may be divided into a first user (e.g., a user who can move using an auxiliary means such as a cane) having a disability degree (mild disability) allowing a little walking and a second user with a severe disability that can only move while in a wheelchair, and when evaluating the movement convenience of the first user and the second user for each of the candidate routes, the route guidance apparatus 100 may operate in a manner in which information on a stair-type interference object is reflected to the first user so that the candidate route including the stair-type interference object can be evaluated to be low in movement convenience, and the candidate route including the stair-type interference object is not selected as a final route for the second user and thus is not calculated for a score for the movement convenience.

In an embodiment, the route guidance apparatus 100 may provide the guidance route information (e.g., the candidate route having the score indicating that the movement convenience is the highest), which is finally selected from among the candidate routes on the basis of the movement convenience, to the target device including the user terminal 200 or the information terminal 300.

More particularly, the route guidance apparatus 100 may output the guidance route information by an information output method determined to correspond to the disability information of the user 1.

Hereinafter, a function (operation) will be described in detail, in which the route guidance apparatus 100 controls the information output method, which is applied to the target device with which the user interacts, such as the information terminal 300, in a customized manner using the disability information of the user. In other words, the route guidance apparatus 100 may set elements associated with a UPUX of the target device in a customized manner using the disability information of the user, so that the disabled user can easily interact with the elements.

That is, when the disability information of the user is obtained, the route guidance apparatus 100 may set elements (output components) for the information output method that the target device such as the information terminal 300 or the user terminal 200 uses, on the basis of the obtained disability information.

In the description of the embodiment of the disclosure, the elements (output components) associated with the information output method for the user using the target device may include at least one of a visual output element, an auditory output element, and a braille-based output element.

In other words, the route guidance apparatus 100 may adjust the elements associated with the UI/UX of the target device, in a customized manner by considering the user's reduced physical ability on the basis of the disability information including the disability type and disability degree of the user, so that the corresponding user can interact with the target device.

More particularly, the setting of the output component of the information terminal 300 in a customized manner may include providing a customized UI/UX for the user by changing the conventional information input/output method, in which the usability of the disabled user or the like is not taken into consideration, for the information terminal 300 by considering the information access ability of the user, such as the user's vision, mobility, hearing, cognitive ability, and the like on the basis of the disability type of the user, so that pieces of predefined information can be provided (transmitted) through the target device such as the information terminal 300 in a manner that the user can conveniently manipulate and easily understand.

That is, the term “customized setting” in the disclosure may include a conversion rule for converting at least some of the elements related to the conventional UI/UX of the information terminal 300, so that the information terminal 300 can provide the route guidance information with a content, which is the same as that previously provided for non-disabled users and the like, in a form in which the information vulnerable users can conveniently manipulate and easily understand.

In an embodiment, when the user for the disability information is a visually impaired user, the route guidance apparatus 100 may change the output component of the target device into a customized setting in which predetermined information is displayed on the basis of at least one information output method from among a voice output method and a braille output method.

More particularly, for a customized setting including the braille input method as the control input application method and the braille output method as the information output method, the route guidance apparatus 100 may control the information terminal 300 so that the user can access a braille cell module (not shown) provided in the information terminal 300.

In this regard, the braille cell module (not shown) may be placed in a locked state by a predefined locker (e.g., a cover member that restricts an access to the braille cell module (not shown) in a closed state, or the like) so that a plurality of braille protrusions provided in the braille cell module (not shown) are prevented from being contaminated and damaged by preventing the braille cell module (not shown) from being used by users other than the visually impaired user, and the locked state may be selectively released only when the visually impaired user intends to use the information terminal 300. Accordingly, when it is determined that the corresponding user corresponds to the visually impaired user on the basis of the disability information of the corresponding user, the route guidance apparatus 100 may release the locker of the braille cell module (not shown).

For example, when it is determined that the visually impaired user is located away from the information terminal 300 by a distance within a preset distance range on the basis of position information of the user, or it is determined that an expected arrival time of the user to the information terminal 300 calculated on the basis of the position information of the user is within a preset time range, the route guidance apparatus 100 may control the information terminal 300 to release the above-described locker.

In other words, when it is determined that the user is a blind user on the basis of the disability information of the user, the route guidance apparatus 100 may control the target device to allow the corresponding user to access the braille cell module (not shown).

In an embodiment, in relation to the voice output method, the route guidance apparatus 100 may apply a customized setting to the information terminal 300 in such a configuration in which menu items related to the route information provided by the information terminal 300, visual information displayed on a screen in a predetermined moving situation, and the like are converted into voice and the corresponding voice is provided. For example, the route guidance apparatus 100 may provide a list of menus or a list of menu-related control manipulations selectable by the user by a voice output method on the basis of the position of the user 1, the walking situation, the remaining distance to the destination position, and the like. In an embodiment, the route guidance apparatus 100 may apply a customized setting to the information terminal 300 in a such configuration that text information or the like, which is displayed for a user other than the visually impaired user, included in the screen of the information terminal 300 is converted into voice by the voice output method and provided to the user.

In an embodiment, in relation to the braille output method, the route guidance apparatus 100 may convert (braille translation) the menu information, the text information, or the like, which is related to the route guidance information provided from the information terminal 300, into braille text, and provide the braille text through the braille cell module (not shown).

In an embodiment, when the user for the disability information is a hearing-impaired user, the route guidance apparatus 100 may change elements associated with the UPUX of the information terminal 300 to a customized setting in which the information terminal 300 displays information on the basis of at least one information output method from among an intuitive visual information output method and a gesture output method.

In an embodiment, in relation to the intuitive visual information output method, the route guidance apparatus 100 may apply a customized setting to the information terminal 300 in such a configuration that menu information, text information, and the like conventionally provided by the information terminal 300 in connection with information provided through the information terminal 300 are replaced with intuitive visual information, such as intuitive symbols, icons, and pictograms corresponding to the conventional menu information, text information, and the like, or displayed together with the intuitive visual information, so that even illiterate users or the like understand the information provided by the information terminal 300.

In this regard, the route guidance apparatus 100 may include a first conversion algorithm for deriving the intuitive visual information that matches the menu information, the text information, and the like provided by the information terminal 300. For example, the first conversion algorithm may search the external server 400 in which words, vocabularies, and expressions matching the intuitive visual information, such as the symbols, the icons, the pictograms, and the like are combined with each other and stored together, and may select the intuitive visual information corresponding to the menu information, the text information, and the like provided by the information terminal 300. Then, the searched intuitive visual information may be reflected in the customized setting.

In an embodiment, in relation to the gesture output method, the route guidance apparatus 100 may support the hearing-impaired user to understand the information provided from the information terminal 300 in such a way that a sign language (sign language), a spoken language (oral method), or the like, which matches the menu information, the text information, and the like associated with the information terminal 300, is output.

In an example embodiment, the route guidance apparatus 100 may include a second conversion algorithm for converting the menu information, the text information, and the like associated with the information terminal 300 into the gesture output, such as a sign language, so that predetermined information is provided by the gesture output method. More particularly, the second conversion algorithm may include a tool for generating a gesture-based avatar images corresponding to the menu information, the text information, and the like associated with the information terminal 300. The route guidance apparatus 100 may apply a customized setting to the information terminal 300 in such a configuration that the gesture-based avatar image generated from the text information, which corresponds to the menu information chosen by the user or corresponds to information requested by the user, by the second conversion algorithm is displayed on the information terminal 300.

In an embodiment, in this regard, when the disability type of the user is a hearing-impaired type, the route guidance apparatus 100 may control a method to displaying sign language image information, which includes information corresponding to a user input applied to the target device, on the basis of user status information including at least one of position information, body information, and gaze information associated with the user.

More particularly, the route guidance apparatus 100 may adjust the specification (enlargement/reduction degree) and position, in which the sign language image information or oral image information to be described below is displayed, of a display of the target device, on the basis of the user status information. For example, the route guidance apparatus 100 may finely adjust the specification and position of the output image information on the basis of the body information, the gaze information, and the like of the user, so that the hand part of the avatar included in the sign language image information or the face part of the user included in the oral image information is located at a position corresponding to a user's eye level in the display area of the target device.

In an embodiment, according to an embodiment of the disclosure, the route guidance apparatus 100 may control a timing, at which the sign language image information or the oral image information is displayed on the display or enlarged and displayed on the display, according to the size of the output information provided to the user through the target device.

According to an embodiment of the disclosure, the user status information (particularly, a relative position of the target device of the user, the size (arm length) of the body part, viewing angle information, and the like are broadly included) can be derived through the analysis using the image data obtained by capturing an image of the user, in the same way for the above-described disability information.

In an embodiment, according to an embodiment of the disclosure, the route guidance apparatus 100 may operate so that the output component is determined to adopt an information transmission method familiar to the hearing-impaired user from among speech reading (oral method), in which the hearing-impaired user understands what the other person is saying by looking at the movement of the speaker's lips and facial expression, and sign language (sign language method), which is a language for transmitting the meaning by changing the shape of the hand and fingers, the direction of the palm, the position of the hand, and the movement of the hand, and the avatar generated in advance selectively outputs the sign language image information, which is expressed through hand gestures, or the oral image information, in which the face area of the pre-generated avatar is enlarged so that the user can easily recognize the change in the shape of the mouth and understand the output information, on the basis of the determined output component.

In this regard, when it is determined that the user is of the hearing-impaired type, the interaction providing apparatus 100 may determine the second element to be based on the sign language method or the oral method on the basis of a user input applied to the target device. Alternatively, the route guidance apparatus 100 may estimate the information transmission method with which the hearing-impaired user is familiar from among the sign language method and the oral method by evaluating whether the user can understand the avatar-based output image, which is output by the sign language method or the oral method according to an initial setting, through the analysis of the user's image data, or analyzing gaze information on each of local areas constituting the output image, and may set the output component in a customized manner to match the estimation result.

For example, when it is determined that the user is of the hearing-impaired type, the interaction providing apparatus 100 may determine the output component as the avatar image of the sign language method according to the initial (basic) setting and output predetermined information, and when it is determined that the ratio of the gaze of the user, who views the avatar image, to the lips area of the avatar is equal to or greater than a preset threshold ratio, the route guidance apparatus 100 may operate to re-output the same information with the avatar image of the oral method by estimating that the corresponding user is a user relatively familiar with oral method communication.

In an embodiment, according to an embodiment of the disclosure, the route guidance apparatus 100 may apply a customized setting to the information terminal 300 in such a configuration that the visibility of various information provided from the information terminal 300 may be improved in consideration of dim-sighted users (e.g., the elderly users) having at least some residual vision. In an example embodiment, the route guidance apparatus 100 may apply a customized setting to the information terminal 300 in such a configuration that various types of visual information displayed on the display, such as texts, images, and media, are provided by magnifying them or improving the contrast, sharpness, resolution, brightness, and the like thereof compared to the conventional ones.

In an embodiment, when the user for the disability information is a physically disabled user, the route guidance apparatus 100 may apply a customized setting to the target device in such a configuration that the information terminal 300 is controlled on the basis of at least one control input application method from among the touch input method using a lower interface of the display, a physical key input method, and the gesture input method.

In still another example, when the disability type of the user is a physical disability type, the route guidance apparatus 100 may control the position and driving method of the auxiliary means input element (e.g., various device manipulation means such as physical keys and a track ball) provided in the target device on the basis of the user status information including at least one of the position information, the body information, and the gaze information associated with the user.

More particularly, the interface, which is displayed on the touch display of the information terminal 300 in a normal state, may include a main area, a touch manipulation area, and an advertising area that are arranged in the up-down direction, so that the normal user conveniently manipulates the touch manipulation area in a standing state. Meanwhile, for the physically disabled user such as a wheelchair occupant, a customized setting may be applied to the information terminal 300 in such a configuration that the lowermost advertisement area is controlled to be removed or moved upward, and a graphic UI is changed so that the touch manipulation area is placed at the lower portion of the display.

In this regard, the position of the touch manipulation area, which is an area of the touch display of the information terminal 300 for receiving the touch input, may be appropriately determined by the customized setting set for the physically disabled user such as the wheelchair occupant, and in addition, the positions of the display and the auxiliary input device may be appropriately changed by through a separate lifter, so that various usability for the physically disabled user may be given to the information terminal 300 disclosed in the disclosure in such a way that the physically disabled user can use the touch display or the auxiliary input device (e.g., physical keys). In an embodiment, the position change control of the touch manipulation area and the control of the lifter (not shown) are applied not only to the physically disabled user such as the wheelchair occupant, but also to child users with small heights, so that the information terminal 300, of course, can improve the use conveniences.

In an embodiment, according to an embodiment of the disclosure, when the determined guidance route information is provided to the target device, the route information guidance apparatus 100 may assist the user 1 moving according to the guided route information to move in a state in which the information on major objects to be passed through is preemptively grasped prior to the journey, by outputting information on the number and position of the interference object A and/or auxiliary object B, which are identified in response to the guidance route information, before guiding a specific route.

In an embodiment, the route information guidance apparatus 100 may obtain position information of the user 1, and on the basis of the determined guidance route information and the position information of the user 1, the route guidance apparatus 100 may output, through the target device, guiding/guidance information for a proceeding direction and progress (progress distance) of the user 1 at the current time point.

According to an embodiment of the disclosure, the route information guidance apparatus 100 may calculate current position information of the user 1 by using information from a positioning sensor mounted on the user terminal 200, or using an infrastructure (not shown) provided in the target space including the departure position and the destination position. For example, the infrastructure (not shown) may refer to a closed circuit television (CCTV), a kiosk terminal, or the like.

Meanwhile, according to an embodiment of the disclosure, the route information guidance apparatus 100 may operate to set in advance a spatial range and/or a time range for obtaining information on the current position of the user 1 on the basis of a range selection input, which is entered to an item of a personal information (position information) collection range applied to the user terminal 200, to selectively obtain the position information of the user 1 only when the user 1 has entered the spatial range or corresponds to a time zone corresponding to the time range set within the set spatial range, and to provide the route guidance information on the basis of the obtained information. In an example embodiment, when the user 1 determines that walking can be made relatively easily without receiving the route guidance information in a predetermined range space around the position of his/her residence, workplace, a specific space with high frequency of visits, and the like, the user 1 may apply, to the user terminal 200, a user input for setting the corresponding space as a spatial range in which the collection of personal information (position information) is restricted, and in response to this, the route information guidance apparatus 100 may operate not to collect (not store) the position information of the user 1 when the user 1 is located in the corresponding space.

In an embodiment, when the user exits the preset spatial range and enters an area where the route information can be guided, or it is determined that the time zone is out of the preset time range, the route guidance apparatus 100 may output, through the user terminal 200, information guiding the fact that the user has entered the area/time zone where the route information can be provided, and may request information on the moving state of the user 1 or information on the destination position to which the user 1 intends to move, so that optimized route guidance information to the destination position is automatically provided to the user 1.

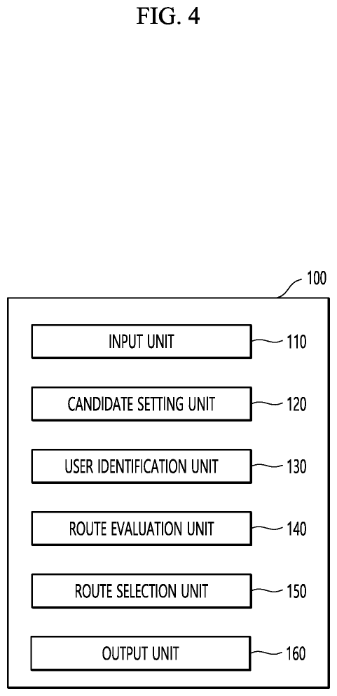

FIG. 4 is a schematic configuration view of an apparatus for guiding customized route based on disability information according to an embodiment of the disclosure.

Referring to FIG. 4, the route guidance apparatus 100 may include an input unit 110, a candidate setting unit 120, a user identification unit 130, a route evaluation unit 140, a route selection unit 150, and an output unit 160.

The input unit 110 may obtain information on a departure position and a destination position from and to which the user 1 intends to move.

The candidate setting unit 120 may select candidate routes from the departure position to the destination position using the information on the departure and departure positions of the user 1 obtained by the input unit 110.

The user identification unit 130 may obtain disability information including a disability type and a disability degree of the user 1. Particularly, the user identification unit 130 may estimate the disability information by receiving the disability information from the user terminal 200 of the user 1, determining the disability information on the basis of a user input applied to a target device (e.g., a device including the user terminal 200 and/or the information terminal 300, or the like) for providing guidance route information, or analyzing image data obtained by capturing an image of the user 1.

The route evaluation unit 140 may evaluate movement convenience of the user 1 for each of the candidate routes in consideration of the disability information of the user 1 obtained by the user identification unit 130. Particularly, the route evaluation unit 140 may evaluate the movement convenience for each of the selected candidate routes by considering at least one from among position information on interference objects, which are located in a target space including the departure position and the destination position from and to which the user 1 intends to move and obstruct the movement of the user, and position information on auxiliary objects located in the target space and assist the movement of the user.

More particularly, when the candidate route is a route on which the interference object is present or the auxiliary object is not present, the route evaluation unit 140 may evaluate the corresponding candidate route to be lower in movement convenience than the other candidate routes.

The route selection unit 150 may determine guidance route information from among the selected candidate routes in consideration of an evaluation result on the movement convenience for each of the candidate routes evaluated by the route evaluation unit 140.

The output unit 160 may provide the target device including at least one of the user terminal 200 and the information terminal 300 of the user 1 with the guidance route information for the optimal route determined in consideration of the movement convenience of the user 1 among the candidate routes.

In this case, the output unit 160 may output the guidance route information by an information output method determined to correspond to the disability information of the user 1.

Particularly, the output unit 160 may obtain position information of the user. In this regard, according to an embodiment of the disclosure, the output unit 160 may calculate the position information of the user 1 by using information from a positioning sensor mounted on the user terminal 200, or using an infrastructure (not shown) provided in the target space including the departure position and the destination position.

In an embodiment, the output unit 160 may output guiding/guidance information on a proceeding direction and progress of the user 1 on the basis of the determined guidance route information and the position information of the user 1.

Hereinafter, the operation flow of the disclosure will be briefly described based on the details given above.

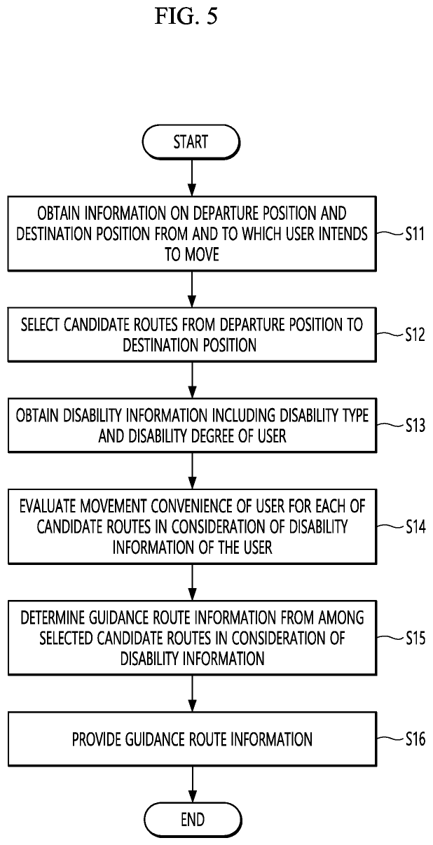

FIG. 5 is an operation flowchart illustrating a method of guiding customized route based on disability information according to an embodiment of the disclosure.

The customized route guidance method based on the disability information illustrated in FIG. 5 may be performed by the route guidance apparatus 100 described above. Thus, although omitted below, the contents described with respect to the route guidance apparatus 100 may be equally applied to a description of the method of guiding customized route based on disability information.

Referring to FIG. 5, in operation S11, the input unit 110 may obtain information on a departure position and a destination position from and to which the user 1 intends to move.

Next, in operation S12, the candidate setting unit 120 may select candidate routes from the departure position to the destination position using the information on the departure position and the destination position obtained in operation S11.

Next, in operation S13, the user identification unit 130 may obtain disability information including a disability type and a disability degree of a user 1.

According to an embodiment of the disclosure, in operation S13, the user identification unit 130 may estimate the disability information of the user 1 by receiving the disability information from the user terminal 200 of the user 1, determining the disability information on the basis of a user input applied to a target device (e.g., a device including the user terminal 200 and/or the information terminal 300, or the like) for providing guidance route information, or analyzing image data obtained by capturing an image of the user 1.

Next, in operation S14, the route evaluation unit 140 may evaluate the movement convenience of the user 1 for each of the candidate routes in consideration of the disability information of the user 1 obtained in operation S13.

Particularly, in operation S14, the route evaluation unit 140 may evaluate the movement convenience for each of the selected candidate routes by considering at least one from among position information on interference objects, which are located in a target space including the departure position and the destination position from and to which the user 1 intends to move and obstruct the movement of the user, and position information on auxiliary objects located in the target space and assist the movement of the user.

More particularly, in operation S14, when the candidate route is a route on which the interference object is present or the auxiliary object is not present, the route evaluation unit 140 may evaluate the corresponding candidate route to be lower in movement convenience than the other candidate routes.

Next, in operation S15, the route selection unit 150 may determine guidance route information from among the selected candidate routes in consideration of an evaluation result in operation S14.

Next, in operation S16, the output unit 160 may provide the guidance route information determined in operation S15 to the target device including at least one of the user terminal 200 and the information terminal 300 of the user 1.

Particularly, in operation S16, the output unit 160 may output the guidance route information by an information output method determined to correspond to the disability information of the user 1.

According to an embodiment of the disclosure, in operation S16, the output unit 160 may obtain position information of the user. Particularly, in operation S16, the output unit 160 may calculate the position information of the user 1 by using information from a positioning sensor mounted on the user terminal 200, or using an infrastructure (not shown) provided in the target space including the departure position and the destination position.

In an embodiment, in operation S16, the output unit 160 may output guiding/guidance information on a proceeding direction and progress of the user 1 on the basis of the determined guidance route information and the position information of the user 1.

In the descriptions given above, operations S11 to S16 may be further divided into additional operations or be combined into fewer operations, according to an embodiment of the disclosure. In an embodiment, some operations may be omitted if necessary, and the order between the operations may be changed.

The method of guiding customized route based on disability information according to an embodiment of the disclosure may be recorded in a computer-readable medium in the form of program instructions that can be executed by various computers. The computer-readable medium described above may include program instructions, data files, data structures, and the like which may be used alone or in combinations thereof. The program instructions recorded in the medium above described may include program instructions that are specially designed and configured only for the disclosure and program instructions that are known and available to those skilled in the art of computer software. The computer-readable recording medium may include hardware devices specially configured to store and execute program instructions. Examples of the hardware devices may include magnetic media such as a hard disk, a floppy disk and a magnetic tape (Magnetic Media), optical media such as a CD-ROM and a DVD (Optical Media), and magneto-optical media (Magneto-optical Media) such as a floppy disk (Floptical Disk), a ROM, a RAM, and flash memory. Examples of the program instructions may include high-level language codes executed by a computer using an interpreter or the like as well as machine language codes such as those generated by a compiler. The hardware devices described above may be configured to operate as one or more software modules so as to perform the operations of the present disclosure, and vice versa.

In an embodiment, the above-described method of guiding customized route based on disability information may be implemented in the form of a computer program or application that is stored on a recording medium and executed by a computer.

According to the above-described problem solving means of the disclosure, it is possible to provide an apparatus and method for guiding customized route based on disability information, capable of searching for and outputting an optimal route from a departure position to a destination position, from or to which a user intends to move, by considering movement convenience according to a disability type and disability degree of the user.

However, the effects obtainable from the disclosure are not limited to the above-described effects, and other effects may exist.

The foregoing descriptions of the disclosure described above are illustrative of example embodiments, and those of ordinary skill in the art to which the disclosure pertains will understand that it can be easily modified into other specific forms without changing the technical spirit or essential features of the disclosure. Therefore, it should be understood that the embodiments described above are illustrative in all respects and not restrictive. For example, each component described as a single type may be implemented in a distributed manner, and likewise components described as distributed may also be implemented in a combined form.

The scope of the disclosure is indicated by the following claims rather than the above detailed description, and all changes or modifications derived from the meaning and scope of the claims and their equivalent concepts should be construed as being included in the scope of the disclosure.

What is claimed is:

1. A method of guiding customized route based on disability information, the method comprising:
selecting candidate routes from a departure position to a destination position from or to which a user intends to move;
obtaining disability information comprising at least one of a disability type or a disability degree of the user;
evaluating movement convenience of the user for each of the candidate routes in consideration of the disability information; and
determining guidance route information from the candidate routes in consideration of an evaluation result.

2. The method of claim 1, wherein
in the evaluating of the movement convenience,
the movement convenience for each of the selected candidate routes is evaluated in consideration of at least one of position information on an interference object located in a target space, which comprises at least one of the departure position or the destination position, and obstructing the movement of the user, or position information on an auxiliary object located in the target space and assisting the movement of the user.

3. The method of claim 2, wherein
in the evaluating of the movement convenience,
when the candidate route is a route on which the interference object is present or the auxiliary object is not present, the candidate route is evaluated to be lower in movement convenience than the other candidate routes.

4. The method of claim 2, wherein the interference object comprises at least one of a first type object disposed being fixed in the target space or a second type object variably disposed in the target space.

5. The method of claim 2, wherein the auxiliary object comprises at least one of a braille guidance block, an elevator, a wheelchair lift, or a guidance traffic light.

6. The method of claim 1, further comprising providing the determined guidance route information to a user terminal of the user,
wherein in the providing of the guidance route information,
the guidance route information is output by an information output method determined to correspond to the disability information.

7. The method of claim 1, wherein
in the obtaining of the disability information,
the disability information is estimated by receiving the disability information from a user terminal of the user, determining the disability information on the basis of a user input applied to a target device for providing the guidance route information, or analyzing image data obtained by capturing an image of the user.

8. The method of claim 6, wherein
the providing of the guidance route information comprises:
obtaining position information of the user; and
outputting guiding/guidance information on a proceeding direction and progress of the user on the basis of the guidance route information and the position information.

9. The method of claim 8, wherein
in the obtaining of the position information,
the position information is calculated by using information from a positioning sensor mounted on the user terminal or an infrastructure provided in a target space comprising at least one of the departure position or the destination position.

10. An apparatus for guiding customized route based on disability information, the apparatus comprising:
a candidate setting unit configured to select candidate routes from a departure position to a destination position from or to which a user intends to move;
a user identification unit configured to obtain disability information comprising at least one of a disability type or a disability degree of the user;
a route evaluation unit configured to evaluate movement convenience of the user for each of the candidate routes in consideration of the disability information; and
a route selection unit configured to determine guidance route information from the candidate routes in consideration of an evaluation result.

11. The apparatus of claim 10, wherein the route evaluation unit evaluates the movement convenience for each of the selected candidate routes is evaluated in consideration of at least one of position information on an interference object located in a target space, which comprises at least one of the departure position or the destination position, or obstructing the movement of the user, and position information on an auxiliary object located in the target space and assisting the movement of the user.

12. The apparatus of claim 11, wherein the route evaluation unit evaluates the candidate route to be lower in movement convenience than the other candidate routes when the candidate route is a route on which the interference object is present or the auxiliary object is not present.

13. The apparatus of claim 11, wherein the interference object comprises a first type object disposed being fixed in the target space and a second type object variably disposed in the target space, and
the auxiliary object comprises at least one of a braille guidance block, an elevator, a wheelchair lift, or a guidance traffic light.

14. The apparatus of claim 10, further comprising an output unit configured to provide the determined guidance route information to a user terminal of the user,
wherein the output unit outputs the guidance route information by an information output method determined to correspond to the disability information.

15. The apparatus of claim 10, wherein the user identification unit estimates the disability information by receiving the disability information from a user terminal of the user, determining the disability information on the basis of a user input applied to a target device for providing the guidance route information, or analyzing image data obtained by capturing an image of the user.

16. The apparatus of claim 14, wherein the output unit calculates the position information by using information from a positioning sensor mounted on the user terminal, or using an infrastructure provided in a target space including the departure position and the destination position, and outputs guiding/guidance information on a proceeding direction and progress of the user on the basis of the guidance route information and the position information.

17. A customized route guidance system based on disability information, the customized route guidance system comprising:
a target device configured to receive information on a departure position and a destination position according to the movement of a user, receive guidance route information for reaching the destination position from the departure position from a route guidance apparatus, and output the guidance route information; and
the route guidance apparatus configured to select candidate routes from the departure position to the destination position, obtain disability information comprising at least one of a disability type or a disability degree of the user, evaluate movement convenience of the user for each of the candidate routes in consideration of the disability information, determine guidance route information from the candidate routes in consideration of an evaluation result, and provide the guidance route information to a user terminal.

18. The system of claim 17, wherein
in the evaluating of the movement convenience,
the movement convenience for each of the selected candidate routes is evaluated in consideration of at least one of position information on an interference object located in a target space, which comprises at least one of the departure position or the destination position, and obstructing the movement of the user, or position information on an auxiliary object located in the target space and assisting the movement of the user.

19. The system of claim 17, wherein the route guidance apparatus further configured to provide the determined guidance route information to a user terminal of the user,
wherein in the providing of the guidance route information,
the guidance route information is output by an information output method determined to correspond to the disability information.

20. The system of claim 17, wherein
in the obtaining of the disability information,
the disability information is estimated by receiving the disability information from a user terminal of the user, determining the disability information on the basis of a user input applied to a target device for providing the guidance route information, or analyzing image data obtained by capturing an image of the user.
